(19) United States
(12) Patent Application Publication
(10) Pub. No.: US 2008/0141016 A1
(43) Pub. Date: Jun. 12, 2008

(54) Computer System and Related Method for Preventing Failure of Updating BIOS Programs

(76) Inventors: Lung-Chiao Chang, Taipei Hsien (TW); Ming-Sheng Wu, Taipei Hsien (TW); Chieh-Yi Lin, Taipei Hsien (TW); Chih-Hung Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/675,088

(22) Filed: Feb. 15, 2007

(30) Foreign Application Priority Data
Dec. 7, 2006 (TW) 095145649

(51) Int. Cl. G06F 9/00

(52) U.S. Cl. 713/2

(57) ABSTRACT

A computer system includes a central processing unit, a memory bus, a memory unit, and a boot select unit. The memory bus is coupled to the central processing unit. The memory bus includes a plurality of data lines and a plurality of address lines. The central processing unit is capable of accessing data through the plurality of data lines and the plurality of address lines. The memory unit includes a plurality of memory blocks. Each of the plurality of memory blocks includes a start address and an end address for storing a BIOS program. The boot select unit is coupled to the memory bus and to the memory unit for selecting a BIOS program stored in one memory block from the plurality of memory blocks to boot the computer system according to a control signal.

### BACKGROUND OF THE INVENTION

1. Field of the Invention

The present invention relates to a computer system and related method for preventing failure of updating BIOS programs, and more particularly, to a computer system and related method utilizing a boot select unit to select the BIOS program stored in one memory block from the plurality of memory blocks to boot the computer system.

2. Description of the Prior Art

Currently, most computer systems utilize a basic input/output system (BIOS) program that is stored in non-volatile memory, and which is first executed by a central processing unit (CPU) when the computer system is turned on. Besides providing key low-level support for device drivers and operating systems, the BIOS program contains a power on self-test (POST) program, and a bootstrap program. The POST program ensures that the basic components of the computer system are operating correctly. After a successful completion of the POST program, the BIOS program executes the bootstrap program, the purpose of which is to load boot code into memory to boot an operating system. All of this is well known in the art of computer systems.

Please refer to FIG. 1. FIG. 1 is a diagram showing a basic input/output system architecture of a computer system 10 in the prior art. The computer system 10 is an embedded system and includes a central processing unit 12, a memory bus 14, and a memory unit 16. The memory bus 14 is coupled to the central processing unit 12 and includes a plurality of data lines and a plurality of address lines (not shown in FIG. 1). The central processing unit 12 is capable of accessing data through the memory bus 14 to control operations of the computer system 10. The memory unit 16 is used for storing a BIOS program BIOS.

In order to prevent failure of updating BIOS programs or damage from viruses that result in damaging the BIOS program, a concept of dual-BIOS is provided in the prior art. Please refer to FIG. 2. FIG. 2 is a diagram showing another basic input/output system architecture of a computer system 20 in the prior art. The computer system 20 includes a central processing unit 22, a memory bus 24, a first memory unit 26, a second memory unit 27, and a switching device 28. The difference between the computer system 20 and the computer system 10 is that the computer system 20 stores a first BIOS program BIOS1 and a second BIOS program BIOS2 individually through the first memory unit 26 and the second memory 27, and utilizes the switching device 28 to select the BIOS program stored in one of the two memory units to boot the computer system. Therefore, even if the computer system 20 fails to update the first BIOS program BIOS1, it can boot through the second BIOS program BIOS2 by adjusting the settings. However, because one more memory unit is added, not only one more NOR flash memory is needed but also space is wasted.

Please refer to FIG. 3, which is a diagram illustrating the addresses of the central processing unit 12 and the memory unit 16 in FIG. 1. The memory unit 16 is a NOR flash memory, the central processing unit 12 can access data directly due to the NOR flash memory having a plurality of data lines and a plurality of address lines. The capacity of the flash memory depends on an amount of the address lines, for example, a NOR flash memory with a capacity of 1 MB will need 20 address lines, and a NOR flash memory with a capacity of 4 MB will need 22 address lines. Hence, when the central processing unit 12 desires to access the data of the address 0x000000, all address lines of the memory unit 16 are set as 0. At this time, the address 0x000000 of the central processing unit 12 is corresponding to the address 0x000000 of the memory unit 16. When the central processing unit 12 desires to access the data of the address 0x100000, all address lines of the memory unit 16 except the 20^{th} address line are set as 0. At this time, the address 0x100000 of the central processing unit 12 is corresponding to the address 0x100000 of the memory unit 16, which is shown in FIG. 3.

Nowadays, embedded systems utilize a NOR flash memory as a storage device for storing the boot programs. The advantage is that the NOR flash memory can be re-programmed directly by a new BIOS program, which will save the problem and cost of replacing hardware devices. However, during the process of updating the BIOS program, the computer system 10 can result in a crash due to a failure of updating the BIOS programs or damage from viruses. Under this situation, users are left with an unusable device.

### SUMMARY OF THE INVENTION

It is therefore an objective of the present invention to provide a computer system and related method for preventing failure of updating BIOS programs to solve the abovementioned problems.

According to an embodiment in the present invention, a computer system for preventing failure of updating BIOS programs is disclosed. The computer system includes a central processing unit, a memory bus, a memory unit, and a boot select unit. The memory bus is coupled to the central processing unit. The memory bus includes a plurality of data lines and a plurality of address lines, and the central processing unit is capable of accessing data through the plurality of data lines and the plurality of address lines. The memory unit includes a plurality of memory blocks, where each memory block includes a start address and an end address for storing a BIOS program. The boot select unit is coupled between the memory bus and the memory unit for selecting the BIOS program stored in one memory block from the plurality of memory blocks to boot the computer system according to a control signal. The memory unit is a non-volatile memory. The memory unit is a NOR flash memory. The computer system is an embedded system.

According to an embodiment in the present invention, a method for preventing a computer system from failing to update BIOS programs is disclosed. The computer system includes a memory unit, where the memory unit includes a first memory block used for storing a first BIOS program and a second memory block used for storing a second BIOS program. The method includes acquiring a command of updating BIOS programs, setting a next rebooting of the computer system through the second memory block, updating the first BIOS program stored in the first memory block, turning off the computer system when failing to update the first BIOS program stored in the first memory block, and booting through the second BIOS program stored in the second memory block. The method further includes setting the next rebooting of the computer system through the first memory block when succeeding in updating the first BIOS program stored in the first memory block, turning off the computer system, and booting through the first BIOS program stored in the first memory block.

According to another embodiment of the present invention, a method for preventing a computer system from failing to update BIOS programs is disclosed. The computer system includes a memory unit, where the memory unit includes a first memory block used for storing a first BIOS program, a second memory block used for storing a second BIOS program, a third memory block used for backing up the first BIOS program, and a fourth memory block used for backing up the second BIOS program. The method includes acquiring a command of updating BIOS programs, backing up the first BIOS program stored in the first memory block to the third memory block; setting a next rebooting of the computer system through the second memory block, updating the first BIOS program stored in the first memory block, turning off the computer system when failing to update the first BIOS program stored in the first memory block, and booting through the second BIOS program stored in the second memory block. The method further includes setting the next rebooting of the computer system through the first memory block when succeeding in restoring the first BIOS program stored in the first memory block, turning off the computer system, and booting through the first BIOS program stored in the first memory block.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a basic input/output system architecture of a computer system in the prior art.

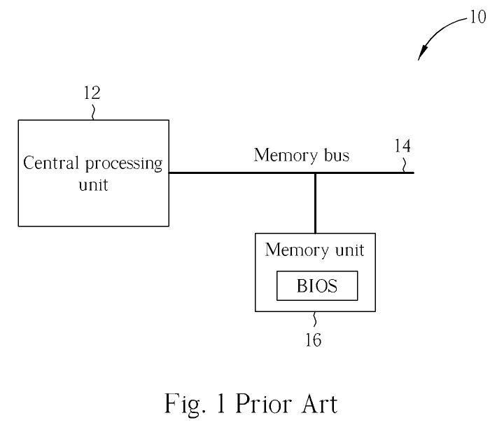

FIG. 2 is a diagram showing another basic input/output system architecture of a computer system in the prior art.

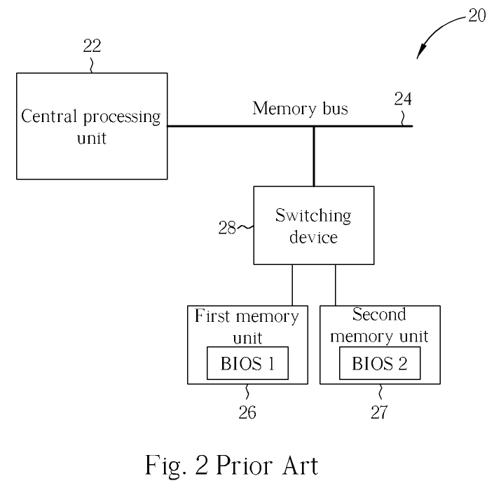

FIG. 3 is a diagram illustrating the addresses of the central processing unit and the memory unit in FIG. 1.

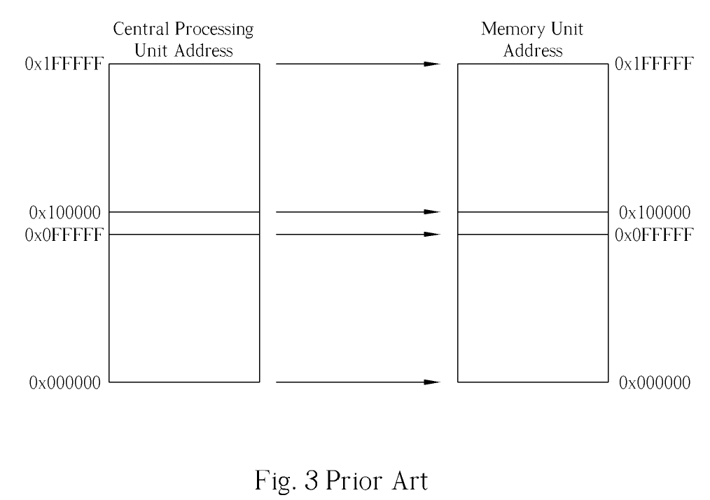

FIG. 4 is a diagram of a computer system for preventing failure of updating BIOS programs according to an embodiment of the present invention.

FIG. 5 is a diagram of a flow illustrating the method for preventing the computer system in FIG. 4 from failing to update BIOS programs.

FIG. 6 is a diagram illustrating the addresses of the central processing unit and the memory unit in FIG. 4.

FIG. 7 is a diagram illustrating the addresses of the central processing unit and the memory unit in FIG. 4.

FIG. 8 is a diagram of a computer system for preventing failure of updating BIOS programs according to another embodiment of the present invention.

FIG. 9 is a diagram of a flow illustrating the method for preventing the computer system in FIG. 8 from failing to update BIOS programs.

FIG. 10 is a diagram illustrating the addresses of the central processing unit and the memory unit in FIG. 8.

FIG. 11 is a diagram illustrating each memory block of the memory unit in FIG. 8.

FIG. 12 is a diagram illustrating the hardware architecture of the boot select unit in FIG. 8.

FIG. 13 is a diagram illustrating the address of each memory block of the memory unit and the output signal in FIG. 11.

### DETAILED DESCRIPTION

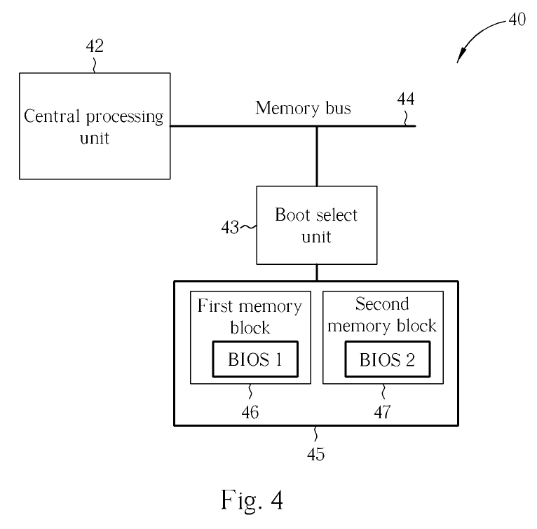

Please refer to FIG. 4. FIG. 4 is a diagram of a computer system 40 for preventing failure of updating BIOS programs according to an embodiment of the present invention. The computer system 40 is an embedded system and includes a central processing unit 42, a memory bus 44, a memory unit 45, and a boot select unit 43. The memory bus 44 is coupled to the central processing unit 42. The memory bus 44 includes a plurality of data lines and a plurality of address lines, and the central processing unit 42 is capable of accessing data through the memory bus 44 to control operations of the computer system 40. The memory unit 45 includes a first memory block 46 used for storing a first BIOS program BIOS1 and a second memory block 47 used for storing a second BIOS program BIOS2, where the first memory block 46 includes a first start address and a first end address and the second memory block 47 includes a second start address and a second end address. The boot select unit 43 is coupled between the memory bus 44 and the memory unit 45 for selecting the BIOS program stored in one memory block from the first memory block 46 or the second memory block 47 to boot the computer system 40 according to a control signal. The memory unit 45 is a non-volatile memory, such as a NOR flash memory. Due to the memory unit 45 having two memory blocks, which can individually be used for storing the first BIOS program BIOS1 and the second BIOS program BIOS2 (can be the same BIOS program or different BIOS programs). Even if the computer system 40 fails to update the first BIOS program BIOS1, it can boot through the second BIOS program BIOS2 by adjusting the settings. Therefore, only one memory unit 45 is needed (such as a NOR flash memory), which will not only lower the cost but also save space. As for the selection of the memory blocks, the operations of the boot select unit 43, and relationships between the addresses of the central processing unit 42 and the memory unit 45 will have a detailed description in the following embodiments.

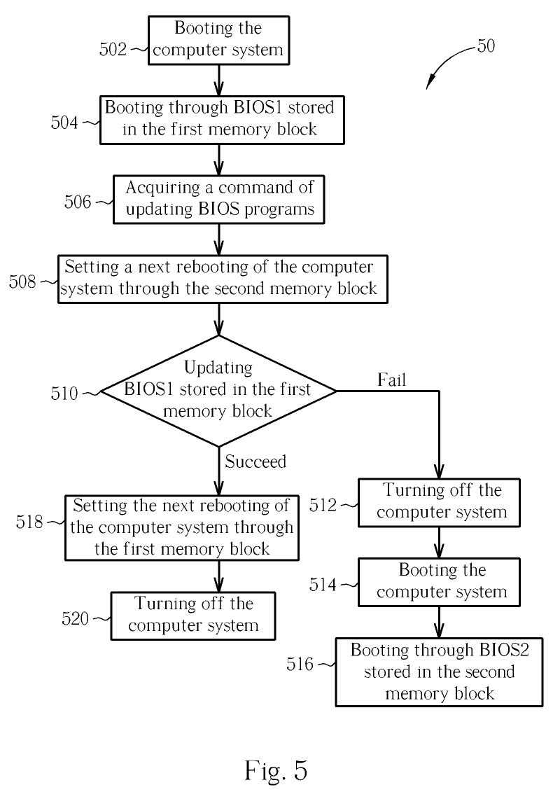

Please refer to FIG. 5 and FIG. 4. FIG. 5 is a diagram of a flow 50 illustrating the method for preventing the computer system 40 in FIG. 4 from failing to update BIOS programs. The flow 50 includes the following steps:

Step 502: Booting the computer system 40.

Step 504: Booting through the first BIOS program BIOS1 stored in the first memory block 46.

Step 506: Acquiring a command of updating BIOS programs.

Step 508: Setting a next rebooting of the computer system 40 through the second memory block 47.

Step 510: Updating the first BIOS program BIOS1 stored in the first memory block 46. If successful in updating the first BIOS program BIOS1, the process goes to step 518; otherwise, the process goes to step 512.

Step 512: Turning off the computer system 40.

Step 514: Booting the computer system 40.

Step 516: Booting through the second BIOS program BIOS2 stored in the second memory block 47.

Step 518: Setting the next rebooting of the computer system 40 through the first memory block 46.

Step 520: Turning off the computer system 40.

In step 508, before updating the first BIOS program BIOS1 stored in the first memory block 46, the next booting of the computer system 40 is set through the second memory block 47. Even if the computer system 40 fails to update the first BIOS program BIOS1, it can boot through the second BIOS program BIOS2 (step 512-516). If successful in updating the first BIOS program BIOS1, the next booting of the computer system 40 is set through the first memory block 46. Then the computer system 40 is turned off, and the next booting of the computer system 40 is through the BIOS program stored in the first memory block 46 (step 518-520). The first BIOS program BIOS1 stored in the first memory block 46 and the second BIOS program BIOS2 stored in the second memory block 47 can be the same or different BIOS programs.

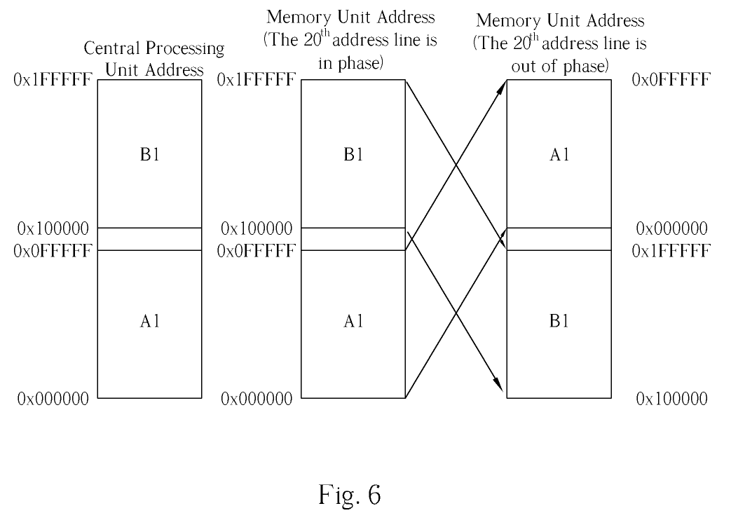

Please refer to FIG. 6 and FIG. 4. FIG. 6 is a diagram illustrating the addresses of the central processing unit 42 and the memory unit 45 in FIG. 4. When the central processing unit 42 desires to access the data of the address 0x000000, all address lines of the memory unit 45 are set as 0. Assume that a signal of the 20^{th} address line (a NOR flash memory with a capacity of 2 MB) or the 21^{st} address line (a NOR flash memory with a capacity of 4 MB) can be inverted (that is 1→0 and 0→1) through the settings of software or hardware, at this time, the central processing unit 42 still believes that it is accessing the data of the address 0x000000 but in fact it is accessing the data of the address 0x100000. In this embodiment, the memory unit 45 is a 2 MB NOR flash memory. As shown in FIG. 6, when the central processing unit 42 desires to access the data of the address 0x000000, the address 0x000000 of the central processing unit 42 is corresponding to the address 0x000000 of the memory unit 46 (marked in a portion A1) if the 20^{th} address line is in phase. Similarly, when the central processing unit 42 desires to access the data of the address 0x000000, the address 0x100000 of the central processing unit 42 is corresponding to the address 0x000000 of the memory unit 46 (marked in a portion B1) if the 20^{th} address line is out of phase.

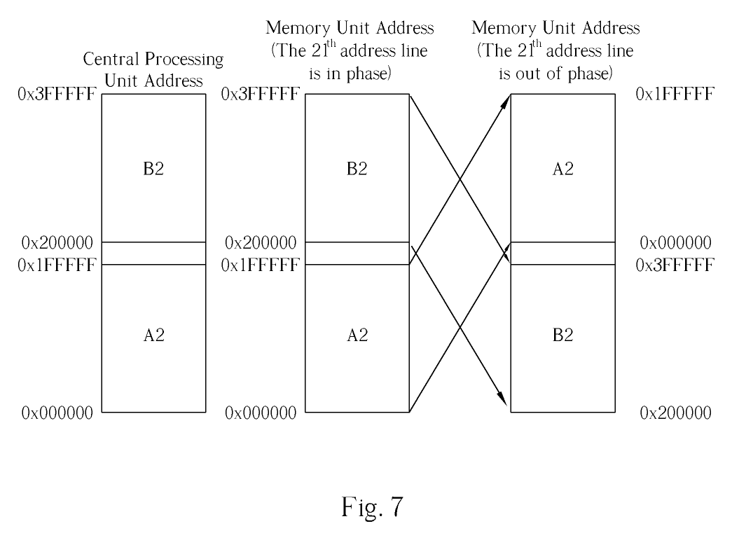

Please refer to FIG. 7 and FIG. 4. FIG. 7 is a diagram illustrating the addresses of the central processing unit 42 and the memory unit 45 in FIG. 4. In this embodiment, the memory unit 45 is a 4 MB NOR flash memory, As shown in FIG. 7, when the central processing unit 42 desires to access the data of the address 0x000000, the address 0x000000 of the central processing unit 42 is corresponding to the address 0x000000 of the memory unit 46 (marked in a portion A2) if the 21^{st} address line is in phase. Similarly, when the central processing unit 42 desires to access the data of the address 0x000000, the address 0x200000 of the central processing unit 42 is corresponding to the address 0x000000 of the memory unit 46 (marked in a portion B2) if the 21^{st} address line is out of phase. The 2 MB or 4 MB NOR flash memories are only used for illustrating the present invention, and their capacity is not limited to this only. The 20^{th} and the 21^{st} address lines are embodiments used for illustration, two or even several address lines can be used at the same time to control the address of the memory unit 45, but these address lines should be the most significant bit of the memory unit 45.

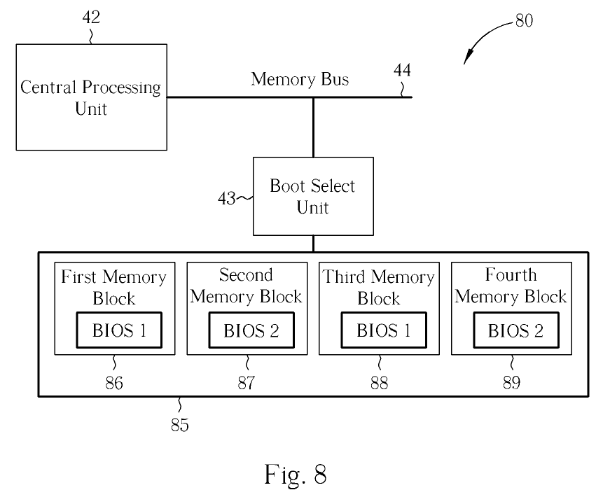

Please refer to FIG. 8. FIG. 8 is a diagram of a computer system 80 for preventing failure of updating BIOS programs according to another embodiment of the present invention. The architecture of the computer system 80 is similar to the computer system 40, the difference between them is that the computer system 80 having a memory unit 85, whereof the memory unit 85 includes a first memory block 86, a second memory block 87, a third memory block 88, and a fourth memory block 89 which has two more memory blocks than the memory unit 45. The first memory block 86 is used for storing the first BIOS program BIOS1, the second memory block 87 is used for storing the second BIOS program BIOS2, the third memory block 88 is used for backing up the first BIOS program BIOS1, and the fourth memory block 89 is used for backing up the second BIOS program BIOS2.

The boot select unit 43 is coupled between the memory bus 44 and the memory unit 85 for selecting a BIOS program stored in one memory block from the first memory block 86 and the second memory block 87 to boot the computer system 80 according to a control signal. Due to the first memory block 86 and the second memory block 87 individually being be used for storing the first BIOS program BIOS1 and the second BIOS program BIOS2, it can boot through the second BIOS program BIOS2 by adjusting the settings of the boot select unit 43 even if the computer system 80 fails to update the first BIOS program BIOS1. Besides, the data backed up in the third memory block 88 can be utilized to restore the first BIOS program BIOS1 stored in the first memory block 86, and the data backed up in the fourth memory block 89 can be utilized to restore the second BIOS program BIOS2 stored in the second memory block 87. As for the selection of the memory blocks, the operations of the boot select unit 43, and relationships between the addresses of the central processing unit 42 and the memory unit 85 will have a detailed description in the following embodiments.

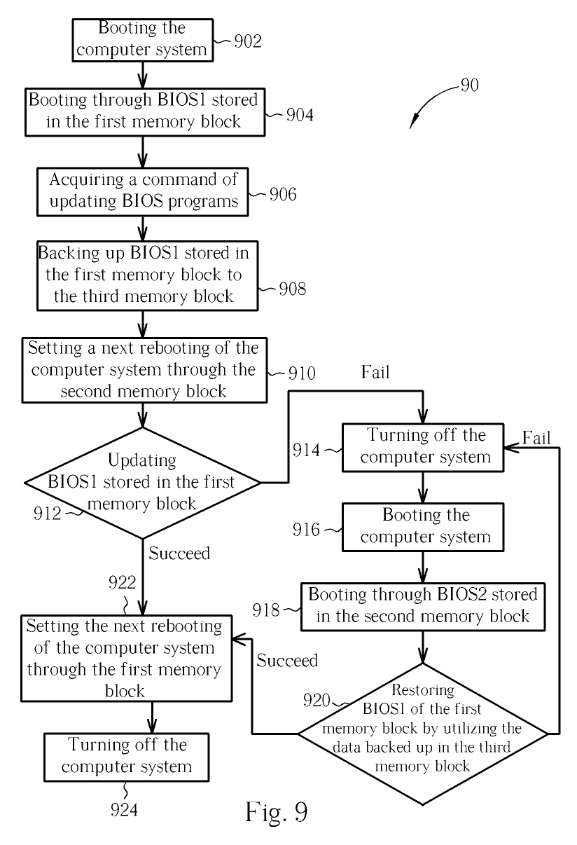

Please refer to FIG. 9. FIG. 9 is a diagram of a flow 90 illustrating the method for preventing the computer system 80 in FIG. 8 from failing to update BIOS programs. The flow 90 includes the following steps:

Step 902: Booting the computer system 80.

Step 904: Booting through the first BIOS program BIOS1 stored in the first memory block 86.

Step 906: Acquiring a command of updating BIOS programs.

Step 908: Backing up the first BIOS program BIOS1 stored in the first memory block 86 to the third memory block 88.

Step 910: Setting a next rebooting of the computer system 80 through the second memory block 87.

Step 912: Updating the first BIOS program BIOS1 stored in the first memory block 86. If successful in updating the first BIOS program BIOS1, the process goes to step 922; otherwise, the process goes to step 914.

Step 914: Turning off the computer system 80.

Step 916: Booting the computer system 80.

Step 918: Booting through the second BIOS program BIOS2 stored in the second memory block 87.

Step 920: Restoring the first BIOS program BIOS1 of the first memory block 86 by utilizing the data backed up in the third memory block 88. If successful in restoring the first BIOS program BIOS1, the process goes to step 922; otherwise, the process goes to step 914.

Step 922: Setting the next rebooting of the computer system 80 through the first memory block 86.

Step 924: Turning off the computer system 80.

In step 908, before updating the first BIOS program BIOS1 stored in the first memory block 86, the first BIOS program BIOS1 stored in the first memory block 86 is backed up to the third memory block 88 first, and then the next booting of the computer system 80 is set through the second memory block 87 (step 910). Even if the computer system 80 fails to update the first BIOS program BIOS1, it can boot through the second BIOS program BIOS2 stored in the second memory block 87 (step 914-918). Besides, the first BIOS program BIOS1 of the first memory block 86 is restored by utilizing the data backed up in the third memory block 88 (step 920). If it succeeds in restoring the first BIOS program BIOS1, then the next booting of computer system 80 is set through the first memory block 86. If it fails to restore the first BIOS program BIOS1, then the next booting of computer system 80 is still set through the second memory block 87. If successful in updating the first BIOS program BIOS1, the next booting of computer system 80 is set through the first memory block 86. After that, the computer system 80 is turned off, and the next booting is through the first BIOS program BIOS1 stored in the first memory block 86. The first BIOS program BIOS1 stored in the first memory block 86 and the second BIOS program BIOS2 stored in the second memory block 87 can be the same or different BIOS programs.

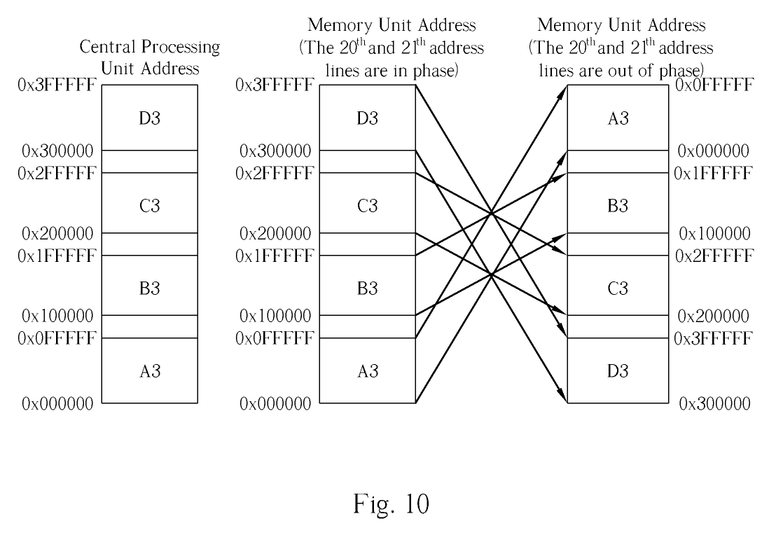

Please refer to FIG. 10 and FIG. 8. FIG. 10 is a diagram illustrating the addresses of the central processing unit 42 and the memory unit 85 in FIG. 8. In this embodiment, the memory unit 85 is a 4 MB NOR flash memory. The operational principles of FIG. 10 is similar to FIG. 7, the memory unit 85 (4 MB) can be viewed as four 1 MB NOR flash memory by controlling whether to invert the signals of the 20^{th} and the 21^{st} address lines of the memory unit 85 at the same time. As shown in FIG. 10, when the central processing unit 42 desires to access the data of the address 0x000000, the address 0x000000 of the central processing unit 42 is corresponding to the address 0x000000 of the memory unit 85 (marked in a portion A3) if both the 20^{th} and the 21^{st} address lines are in phase. Similarly, when the central processing unit 42 desires to access the data of the address 0x300000, the address 0x300000 of the central processing unit 42 is corresponding to the address 0x000000 of the memory unit 85 (marked in a portion D3) if both the 20^{th} and the 21^{st} address lines are out of phase.

When the central processing unit 42 desires to access the data of the address 0x100000, the address 0x100000 of the central processing unit 42 is corresponding to the address 0x100000 of the memory unit 85 (marked in a portion B3) if both the 20^{th} and the 21^{st} address lines are in phase. When the central processing unit 42 desires to access the data of the address 0x200000, the address 0x200000 of the central processing unit 42 is corresponding to the address 0x100000 of the memory unit 85 (marked in a portion C3) if both the 20^{th} and the 21^{st} address lines are out of phase. Therefore, the computer system 80 can boot from different addresses by controlling whether to invert the signals of the 20^{th} and the 21^{st} address lines of the memory unit 85, which not only can reach the goal of multiple booting of system but also no extra NOR flash memory is needed. The 4 MB NOR flash memory is only used for illustrating the present invention, and its capacity is not limited to this only. The 20^{th} and the 21^{st} address lines are embodiments used for illustration, two or even several address lines can be used at the same time to control the address of the memory unit 85.

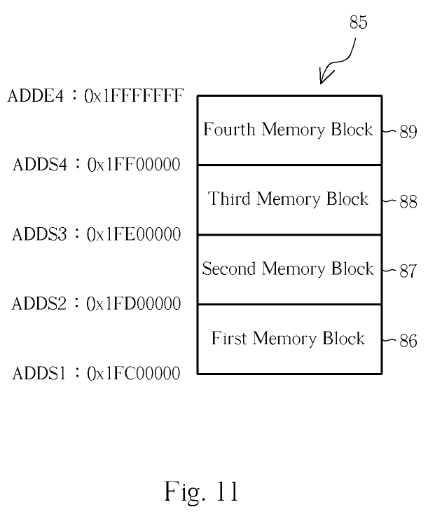

Please refer to FIG. 11 and FIG. 8. FIG. 11 is a diagram illustrating each memory block of the memory unit 85 in FIG. 8. In this embodiment, the memory unit 85 is a 4 MB NOR flash memory and can be viewed as four 1 MB NOR flash memories, which individually are the first memory block 86, the second memory block 87, the third memory block 88, and the fourth memory block 89. The first memory block 86 includes a first start address ADDS1 0x1FC00000, the second memory block 87 includes a second start address ADDS2 0x1FD00000, the third memory block 88 includes a third start address ADDS3 0x1FE00000, and the fourth memory block 89 includes a fourth start address ADDS4 0x1FF00000. The central processing unit 42 generally starts from the address 0x1FC00000, which is the start address of the memory unit 85. Different start addresses can be selected to reach the goal of multiple booting of the system through the control of whether to invert the 20^{th} and the 21^{st} address lines of the memory unit 85.

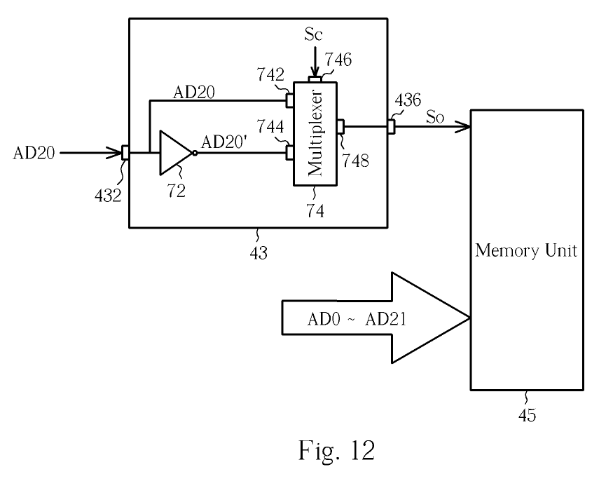

Please refer to FIG. 12, which is a diagram illustrating the hardware architecture of the boot select unit 43 in FIG. 8. The boot select unit 43 includes an input end 432, an inverter 72, a multiplexer 74, and an output end 436. The input end 432 is used for receiving a first address signal AD20. The inverter 72 is coupled to the input end 432 for processing an invert operation on the first address signal AD20 to generate a first inverted address signal AD20′. The multiplexer 74 includes a first input end 742, a second input end 744, a control end 746, and an output end 748. The first input end 742 is used for receiving the first address signal AD20, and the second input end 744 is coupled to an output end of the inverter 72 for receiving the first inverted address signal AD20′.

The control end 746 is used for receiving a control signal Sc to select the first address signal AD20 or the first inverted address signal AD20′ to output at the output end 748. The output end 436 of the boot select unit 43 is coupled to the output end 748 of the multiplexer 74 for outputting an output signal So to the memory unit 45, where the output signal So is the first address signal AD20 or the first inverted address signal AD20′. The memory unit 45 has the plurality of address lines, assuming that the memory unit 45 is a 4 MB NOR flash memory, all the other address signals AD0˜AD21 except the first address signal AD20 will be submitted to the memory unit 45. Please keep referring to FIG. 12 and FIG. 11. When the output signal So is the first address signal AD20, the boot select unit 43 chooses to boot from the first memory block 86; when the output signal So is the first inverted address signal AD20′, the boot select unit 43 chooses to boot from the second memory block 87. Which memory block is selected to boot is determined through controlling whether to invert the output signal So or not.

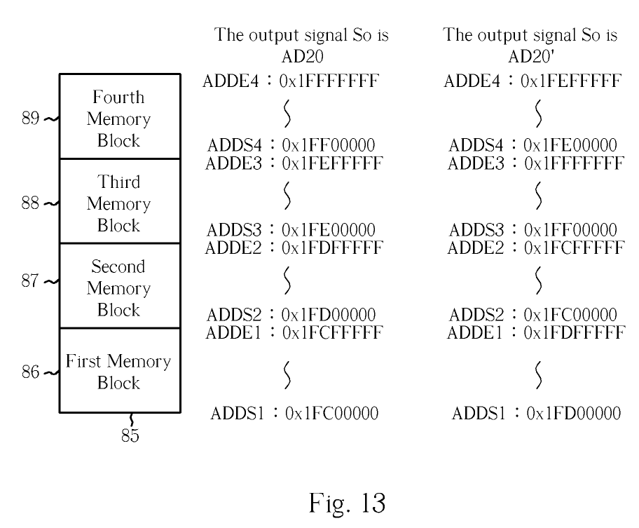

Please refer to FIG. 13. FIG. 13 is a diagram illustrating the address of each memory block of the memory unit 85 and the output signal So in FIG. 11. As shown in FIG. 13, when the output signal So is the first address signal AD20, the first memory block 86 includes the first start address ADDS1 0x1FC00000 and a first end address ADDE1 0x1FCFFFFF, the second memory block 87 includes the second start address ADDS2 0x1FD00000 and a second end address ADDE2 0x1FDFFFFF, the third memory block 88 includes the third start address ADDS3 0x1FE00000 and a third end address ADDE3 0x1FEFFFFF, and the fourth memory block 89 includes the fourth start address ADDS4 0x1FF00000 and a fourth end address ADDE4 0x1FFFFFFF. When the output signal So is the first inverted address signal AD20′, the first memory block 86 includes the first start address ADDS1 0x1FD00000 and the first end address ADDE1 0x1FDFFFFF, the second memory block 87 includes the second start address ADDS2 0x1FC00000 and the second end address ADDE2 0x1FCFFFFF, the third memory block 88 includes the third start address ADDS3 0x1FF00000 and the third end address ADDE3 0x1FFFFFFF, and the fourth memory block 89 includes the fourth start address ADDS4 0x1FE00000 and the fourth end address ADDE4 0x1FEFFFFF.

The abovementioned embodiments are presented merely for describing the present invention, and in no way should be considered to be limitations of the scope of the present invention. The 2 MB or 4 MB NOR flash memories are only used for illustrating the present invention, and their capacity is not limited to this only. The 20^{th} and the 21^{st} address lines are embodiments used for illustration, two or even several address lines can be used at the same time to control the address of the memory unit 45. The memory unit 45 can be divided into 2n memory blocks offering to the central processing unit by way of controlling whether to invert the address signals or not. Furthermore, the first BIOS program BIOS1 stored in the first memory block 86 and the second BIOS program BIOS2 stored in the second memory block 87 can be the same or different BIOS programs.

From the above descriptions, the present invention provides a computer system and related method for preventing failure of updating BIOS programs. Due to the memory unit 45 having two (or 2n) memory blocks, which can individually be used for storing one BIOS program (can be the same or different BIOS programs), it can boot through the other BIOS program by the settings of the boot select unit 43 even when the computer system fails to update one of the BIOS programs or the BIOS program is damaged. Therefore, only one memory unit is needed (such as a NOR flash memory), which will not only lower the cost but also save space. Besides, the memory unit 45 can be re-programmed directly by a new BIOS program and will not be damaged easily, which will help the users save the problem of replacing hardware devices.

Those skilled in the art will readily observe that numerous modifications and alterations of the device and method may be made while retaining the teachings of the invention. Accordingly, the above disclosure should be construed as limited only by the metes and bounds of the appended claims.

1-8. (canceled)

9. A method for preventing a computer system from failing to update BIOS programs, the computer system comprising a memory unit and the memory unit comprising a first memory block used for storing a first BIOS program, a second memory block used for storing a second BIOS program, a third memory block used for backing up the first BIOS program, and a fourth memory block used for backing up the second BIOS program, the method comprising:
acquiring a command of updating BIOS programs;
backing up the first BIOS program stored in the first memory block to the third memory block;
setting a next rebooting of the computer system through the second memory block;
updating the first BIOS program stored in the first memory block;
turning off the computer system when failing to update the first BIOS program stored in the first memory block; and
booting through the second BIOS program stored in the second memory block, wherein the second BIOS program contains different program code than the first BIOS program.

10. The method of claim 9 further comprising:
restoring the first BIOS program of the first memory block by utilizing the data backed up in the third memory block.

11. The method of claim 10 further comprising:
setting the next rebooting of the computer system through the first memory block when succeeding in restoring the first BIOS program stored in the first memory block;
turning off the computer system; and
booting through the first BIOS program stored in the first memory block.

12. The method of claim 10 further comprising:
turning off the computer system when failing to restore the first BIOS program stored in the first memory block; and
booting through the second BIOS program stored in the second memory block.

13. The method of claim 9 further comprising:
setting the next rebooting of the computer system through the first memory block when succeeding in updating the first BIOS program stored in the first memory block;
turning off the computer system; and
booting through the first BIOS program stored in the first memory block.
